(19) United States
(12) Patent Application Publication
(10) Pub. No.: US 2010/0242824 A1
(43) Pub. Date: Sep. 30, 2010

(54) Device at a Line Winch

(75) Inventor: Jan Karlsson, Vastra Frolunda (SE)

Correspondence Address: POTOMAC PATENT GROUP PLLC, P. O. BOX 270, FREDERICKSBURG, VA, 22404, US

(73) Assignee: Selden Mast AB, Vastra Frolunda (SE)

(21) Appl. No.: 12/740,398

(22) PCT Filed: Nov. 7, 2008
(86) PCT No.: PCT/IB08/54674

§ 371 Date: Apr. 29, 2010

(30) Foreign Application Priority Data
Nov. 9, 2007 (SE) 0702478-9

(51) Int. Cl. B66D 1/74

(52) U.S. Cl. 114/268

(57) ABSTRACT

Method and a device (1) at a motor driven line winch (2) for sailing boats comprising a rotatably mounted line drum (3) around which a line (4) for sail and halyard is windable. According to the invention, more than one electrical motor is arranged in order to in different manners in different engagement patterns be possible to be coupled together in order to thereby actuate the winch (2) by different desired power and be able to optimize the total efficiency of the device.

The present invention relates to a method and a driving device at a line winch comprising a cantilevered one-sidedly rotatably mounted line drum, around which a line for sail and halyard is windable.

Motor driven winches intended for lines of boats where it is desired to be able to utilize a winch in order to obtain desired force actuation on the line in question, e.g., in order to adjust sail and rig on board, have a determined maximum power from the beginning. The power requirement may vary and it may then many times prove difficult and inappropriate to utilize a winch that is altogether too strong in relation to the operation to be carried out. To utilize a winch having altogether too small maximum motor output is if possible even more difficult and even more inappropriate. Therefore, it would be desirable to be able to vary the power of the winch according to needs and requirements of the same while maintaining a good efficiency, a property that hardly coincides with known motor techniques. In cars of so-called hybrid type where petrol or gasoline engines and electric motors, which are permanently arranged in the car in question, the motors/engines co-operate during increased power requirement and increase the power output from the engine/motor that normally is utilized during lower power requirements. However, the motors/engines are fixedly arranged in place in the car. There are winches of the above-mentioned type which comprise more than one motor. An example of such a one provided with more than one motor is shown in e.g., JP 2006096500, where one of two motors continues to work even if one motor breaks down (redundant arrangement). US 2002/0092454 A1 shows a motor driven winch having electrical motor and brake contained in the winch. This is also provided with means for manual actuation. However, these known solutions do not meet the objective to be able to vary the power of the winch according to needs and the requirement that this should be possible while maintaining best feasible efficiency.

Therefore, the main object of the present invention is to be possible to adapt the driving power of the winch when needs for more power are present, e.g., when it is desired to manoeuvre great sails in rough wind. Essential is also that it is desired to provide decreased current consumption by obtaining better efficiency thanks to the fact that it is possible to drive the motors sequentially during rotational speed advantageous for each motor. Gearings may also be chosen individually or in combination in order to optimize the efficiency by different states of the rotational speed register of the motors, i.e., that the respective motor principally is driven within its own speed range for the winch as a whole. Accurate regulation is also possible to provide by utilizing small motors and thereby get a low current consumption. Small motors can be packed denser, whereby a higher power density is attained.

Said object is attained by a device according to the present invention, which is characterized in that it has at least two electrically driven motors (5) having pinions 20 and free wheel-clutches 15 arranged between the respective motor and the respective pinion 20, the motors (5) being drivable separately or together in order to by means of the desired power or best efficiency drive the winch (2) via gearings (11).

An advantage of utilizing a plurality of motors is that it is possible to utilize the power-wise optimal speed range of the respective motor and accordingly drive the respective motor within the power range and/or speed range that best fits the respective motor in order to all in all obtain a multiplied power so that the efficiency of the respective motor is utilized maximally.

In this way, a possibility is attained to efficiency-wise utilize the motors optimally when occasion is given. By efficiency-wise, reference is accordingly made to not only the kilowatt number but rather that the respective motor in the normal case only is run in a speed range where the efficiency thereof is highest. However, under extreme circumstances, an overlapping between the operationally feasible rotational speeds of the motors may mean that more than one motor is run simultaneously.

By the fact that the utilized motors are small, they have a low self-mass, wherein a so-called after run upon shut off can be minimized. In addition, such small motors are simple to adjust accurately.

By the fact that the different motors are given different gearing as well as the arrangement of freewheels on the pinions of all motors, a greater speed range of the winch is obtained at the same time as those motors that at higher rotational speeds are disconnected are not driven along and thereby overspeeding.

The arrangement of freewheels on the respective pinion entails in addition a simple switch over between the different motors when they go in engagement in connection with the rotational speed of the winch drum and the rotational speed of the motor coinciding.

The invention will in the following be described in more detail, reference being made to an embodiment example shown in the accompanying drawing figures, where:

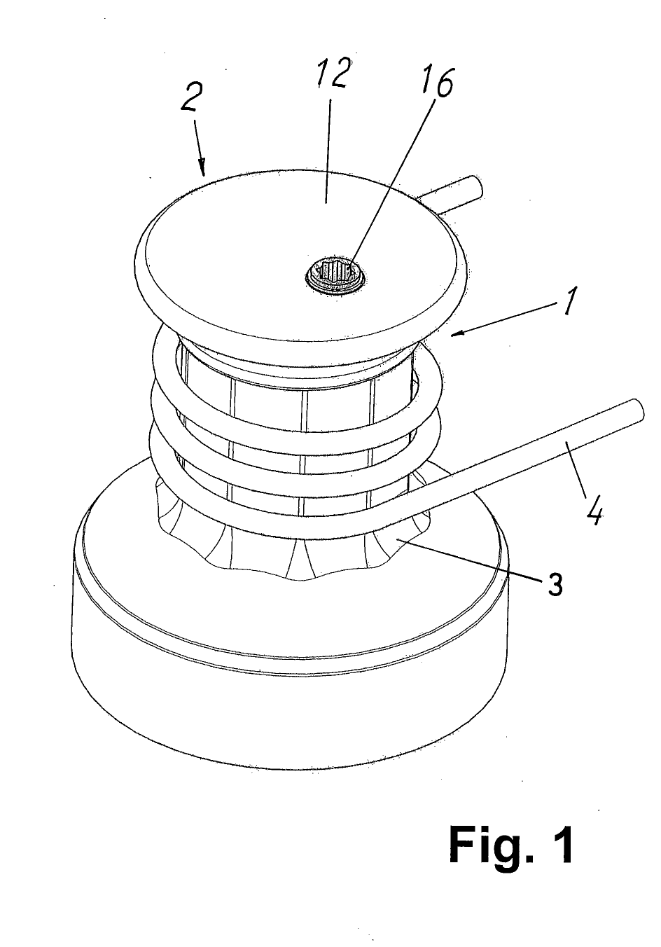

FIG. 1 shows a boat winch,

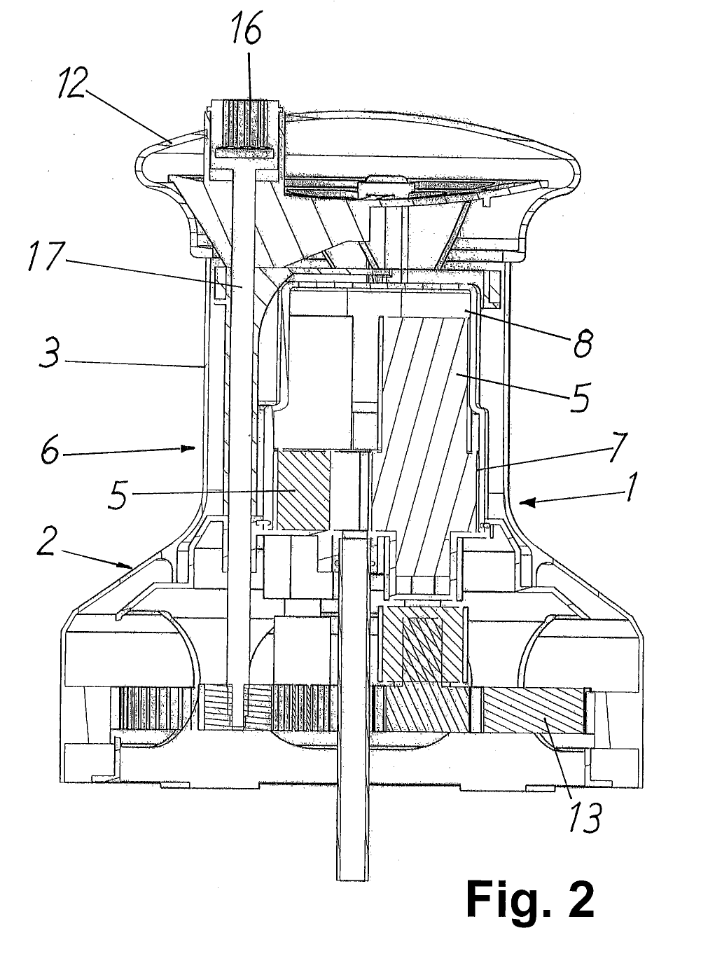

FIG. 2 shows a cross-sectional view of a winch, which is provided with a device according to the present invention and which is shown in a winch-prepared state,

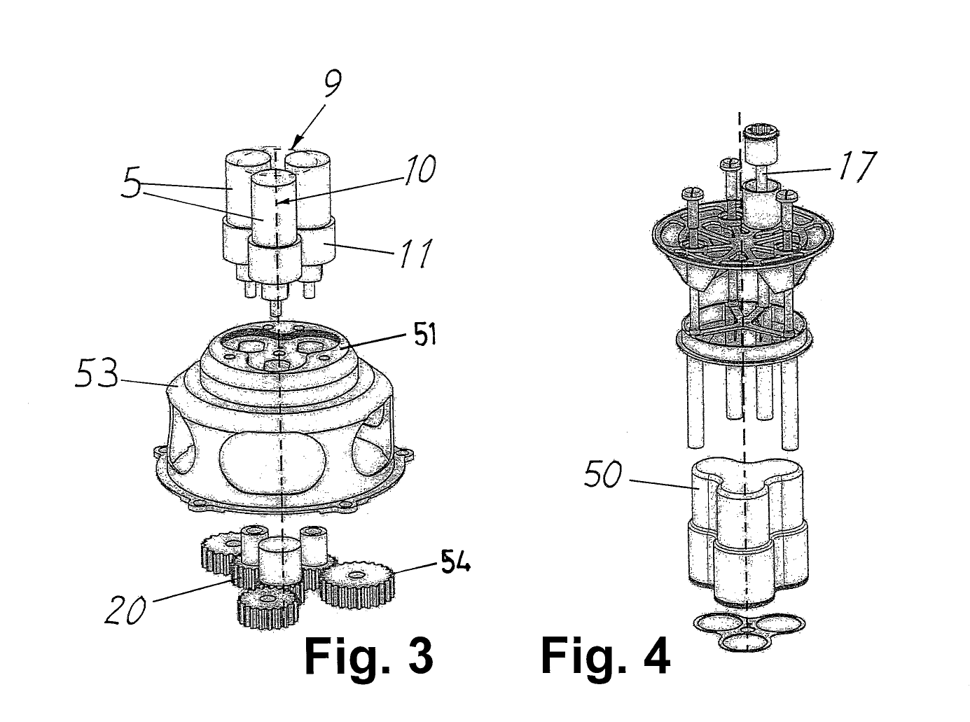

FIG. 3 shows a view with the parts spaced-apart of the lower part of a winch having loose removable electric motors receivable therein,

FIG. 4 shows a view with the parts spaced-apart of the upper part of a winch with parts included therein,

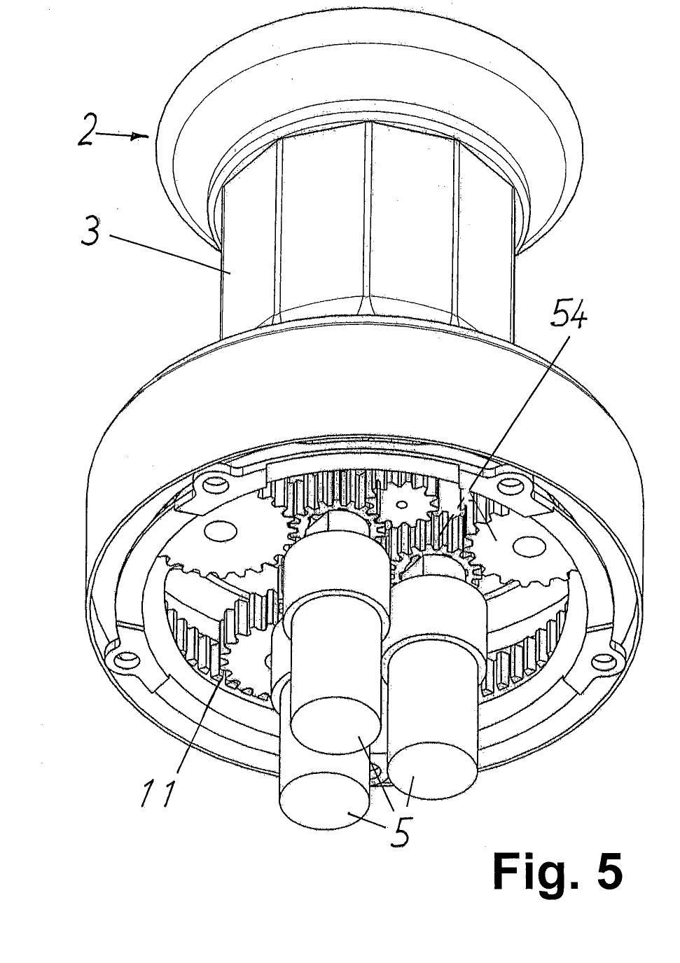

FIG. 5 shows obliquely from below a variant of a winch and motors applicable from below,

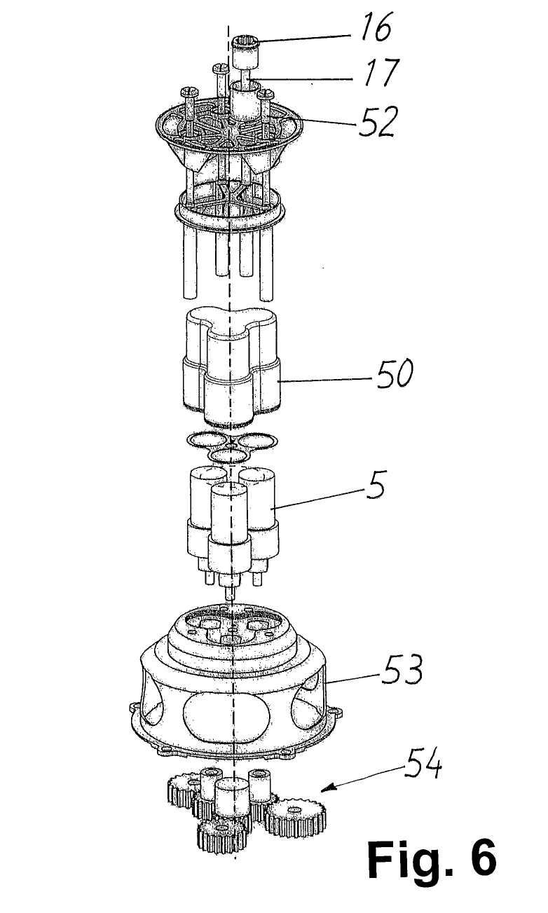

FIG. 6 shows a view with the parts spaced-apart of a winch with a device according to the invention applicable therein,

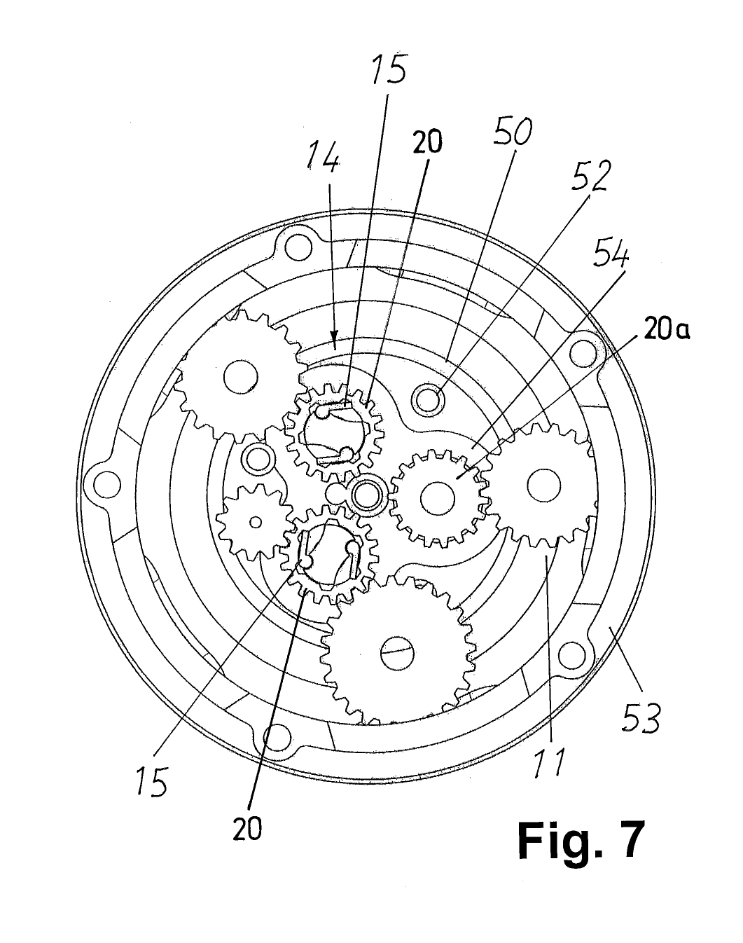

FIG. 7 shows the winch having gears and freewheel-clutches included therein as seen from the underside of the winch, and

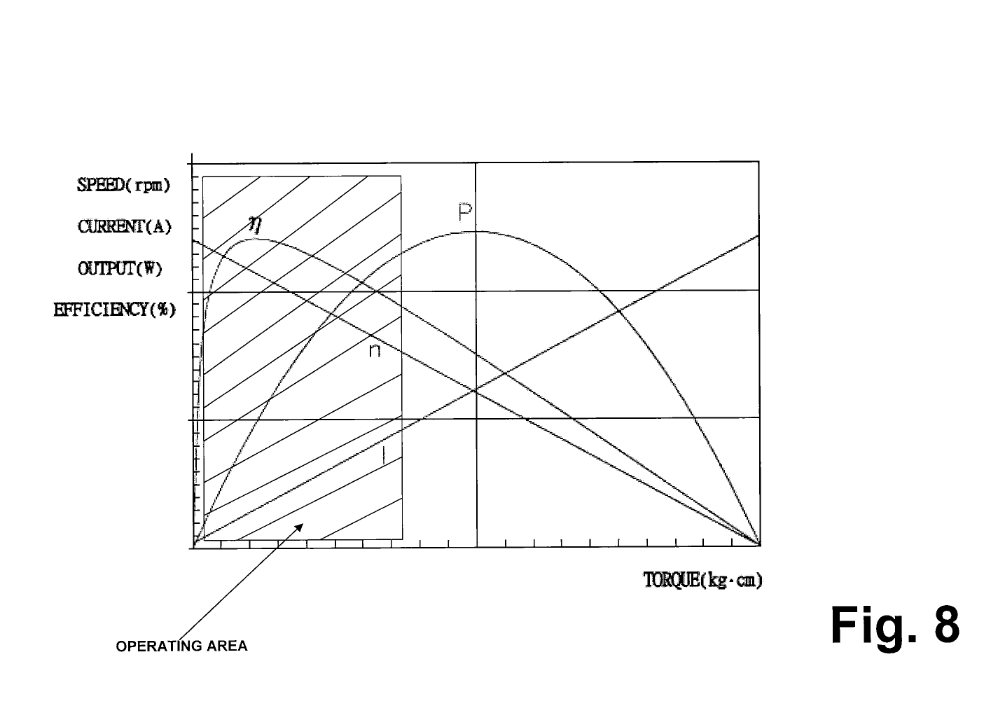

FIG. 8 shows an integrated diagram over speed, efficiency, power output and current consumption as a function of produced torque of a motor of the type that is used.

A device 1 according to the present invention is arranged at a line winch 2 of the type that is intended to be used on board boats in order to manoeuvre sail, halyard and other force-actuatable parts on board the boat in question. The device 1 comprises a cantilevered rotatably mounted line drum 3, around which a line 4 is windable as well as at least two motors 5 in order to drive said drum 3. The motors are arranged in a fairly special manner. The arrangement 5, 6 comprises either that more than one recess 7, which are intended for receipt of an electrically driven motor 5 each, are arranged in the internal space 8 of the winch or that a plurality of motors 5 are arranged outside the winch, for instance under deck of the boat on which the winch is arranged. Thereby, the desired number of motors 5 can be arranged to be possible to be coupled together to a common unit in order to thereby provide a drive package, which depending on the use of the winch, on one hand can selectably be equipped with motors having different characteristics and on the other hand can be provided with a control equipment, which controls the driving of the entire motor package in respect of desired properties. Desired properties may be an optimization of the total efficiency of the winch irrespective of the winch speed or utilization of the optimal speed ranges of the electric motors in respect of, for example, given moment.

The motor recesses 7, which may vary in number all the way from two up to a large number, e.g., ten, are preferably arranged evenly distributed along the circumference 9 of the central axis 10 of the winch. The recesses 7 are shape-adapted to the outer shape of the motors in order to therein be able to receive a motor 5 each being entirely contained in the winch 2 inside the outer limiting edges of the winch. Gears 11, as mentioned above, can be arranged internally in the winch 2, or outside the proper winch 2 under the line drum 3 of the winch. It is also possible with a combination of gears and motors, respectively, which are arranged inside the winch, as well as outside under the same, so that they later in the mounted state of the winch end up under deck of the boat in question. The gears are arranged so that the motors 5 co-operate with the respective gear 11 and drive the line drum 3 of the winch either separately or jointly depending on how many motors 5 that are engaged simultaneously. The driving cogwheel 20 of each motor 5 in the respective gear 11 is provided with a freewheel clutch 15 (see FIG. 7) in order to prevent that a motor for the moment not being engaged compulsory has to be rotated along when a motor which, when it is driven, gives the winch drum a higher rotational speed, is in use. A cover lid 12 of plastic or metal is detachably fastened at the upper part of the winch in order to enable mounting and dismounting, respectively, of preferably cylindrical elongate rod-like motors when required. The motors may be of the similar type as used in electrically driven drilling machines and other hand tools.

The gear of the winch 2 in question preferably consists of a gear 11, the respective motor 5 being arranged to by the respective driving cogwheel 20 thereof be in constant engagement in the gear 11 via a respective cogwheel 13 as intermediate wheel.

In the winch 2, a brake 14 is included, for instance of the type that has been shown to be previously known by EP 0756575 B1. The freewheel clutch 15 is in addition intended to prevent that the motor/motors 5, which is/are not connected to the brake 14, is/are co-rotated in the case the drum 3 is driven manually, such as by means of a crank detachably connected in an opening 16 of the upper side 3A of the winch to a drive shaft 17, which extends through the interior of the winch. Said brake 14 is arranged to block the drum 3 and prevent that the same during load rotates in a direction of rotation, which also is denominated outhauling direction. A motor 5 received in the winch, which motor by its gearwheel 20a is coupled over the brake 14, is arranged to during backing thereof loosen the brake 14, which is released as long as the motor goes rearward, so that the drum 3 is enabled to freely be rotated in the opposite direction (out-hauling). The freewheel coupling of the gear wheel 20A is due to its co-operation with the brake 14 of a different construction as compared with the wheels 20 (see for instance EP 0 756 575B1).

The gearing between at least two motors 5 and the drum 3 differs, whereby different common motor and gear changing units are obtained which, in case of desired needs, may be engaged and disengaged according to needs in order to give the winch 2 the desired properties. For instance, at a first stage, motor I may be engaged. After a while, motor II may be engaged. When eventually the rotational speed becomes such that the motor efficiency of motor I is decreased to a certain rate, the same is disengaged. Then motor III may be engaged. Thus, a flexible winch is obtained having the appurtenant electric motors between which it is easy to alternate. In a preferred embodiment of the invention, a control system (not shown) is arranged in order to handle engagement and disengagement of the different motors in respect of rotational speeds and efficiency. The handling preferably takes place based on a measuring of current consumption in combination with registration of the rotational speed in question of the respective motor as well as knowledge about the input data of the respective motor, such as efficiency as a function of rotational speed or at which rotational speed the maximum moment is given or possibly maximum rotational speed for the respective motor.

In the drawings, it is shown in FIG. 6 how the motors 5 are received in a protective cover 50, which is arranged to be retained in a frame 51. By means of bolts 52, said protective cover 50, which is liquid tight, is fastened at the upper part of a winch frame 53. Around the motors 5 and the protected protective cover 50, a winch drum 3, not shown, is mountable. Driving or intermediate wheels 54 for torsion transfer from the driving wheels 20 in the gear 11 of the motors 5 are receivable at the lower part of the winch. A crank opening 16 having connected drive shaft 17 for manual driving actuation of the winch 2 is shown in FIG. 6.

In FIG. 8, an integrated diagram is seen over speed (rpm), efficiency (η(%)), power output (p(W)) and consumption of current (I(A)) as a function of produced torque (M(Nm)) of a motor of the type that is used for the device according to the invention. In the figure an optimum operating area is marked, which means that by means of different gearings between the respective motors 5 and the line drum 3, it is intended that the driving of the drum as far as possible should be effected with at least one motor in operation within the optimal operation area thereof.

The nature and function of the invention are seen in the description above and the embodiment example shown in the drawings. However, the invention is not considered as limited to what has been described above and the embodiment shown in the accompanying drawings. Modifications are feasible, particularly as for the nature of the different parts, or by usage of equivalent technique, without departing from the protection area of the invention, such as it is defined in the claims.

1-17. (canceled)

18. A device at a motor driven line winch for sailing boats, comprising:
a cantilevered one-sidedly journaled line drum, around which a line for sail and halyard is windable; and
at least two electric motors having pinions and freewheel clutches arranged between a respective motor and a respective pinion, the motors being drivable separately or together in order to drive the winch via a gearing according to a desired power, a best efficiency, or a most accurate control.

19. The device of claim 18, further comprising more than one recess for receipt of an appurtenant electric motor, whereby a desired number of motors in the respective recess can be coupled together in order to exert desired power on the winch.

20. The device of claim 19, wherein the recesses are arranged along a circumference of a central axis of the winch.

21. The device of claim 19, wherein the recesses are shape-adapted to outer shapes of the motors in order to therein receive a motor each entirely contained in the winch.

22. The device of claim 20, wherein the recesses are evenly distributed along the circumference of the winch and entirely contained inside outer limiting edges of the winch.

23. The device of claim 18, wherein the gearing is a toothed gearing, and each motor is interconnectable with the gearing.

24. The device of claim 18, further comprising a brake included in the winch.

25. The device of claim 24, wherein an overrunning clutch is arranged to prevent a motor which is not connected to the brake from rotating when the drum is rotated manually.

26. The device of claims 24, wherein the brake is arranged to block the drum from rotating in a direction of rotation.

27. The device of claim 26, wherein a motor, which is coupled over the brake, is arranged to detach, upon backing of the motor, a backstop so that the drum is enabled, under impact of outer force from a line wound on the drum, to outhaul, thereby rotating in an opposite direction.

28. The device of claim 27, wherein upon backing, all motors of the winch are backed by being run with the opposite direction of rotation.

29. The device of claim 18, wherein the gearing is contained in an internal space of the winch.

30. The device of claim 18, comprising different gearings between each motor and the drum.

31. The device of claim 18, wherein the motors are arranged to be contained in a protective cover received in the line drum of the winch.

32. The device of claim 18, wherein the motors are arranged to be received on an underside of the winch in a mating space below deck when the winch is mounted on deck.

33. The device of claim 32, wherein the gearing is contained in an internal space of the winch arranged outside under the line drum.

34. A method of controlling a motor-driven line winch for sailing boats having a cantilevered one-sidedly mounted line drum around which a line for sail and halyard is windable, the winch having at least two electric motors having respective pinions attached on respective shafts thereof, the method comprising:
arranging overrunning clutches between the shafts and the pinions, which prevent co-rotation of an armature of at least one of the motors when the winch is driven either by highest speed motor or manually by a crank.
